(19) United States
(12) Patent Application Publication
(10) Pub. No.: US 2005/0142357 A1
(43) Pub. Date: Jun. 30, 2005

(54) High strength pressure sensitive adhesive

(75) Inventors: Michael Zajaczkowski, New Holland, PA (US); Kevin McKinney, Seven Valleys, PA (US); Andy Hogan, Seven Valleys, PA (US); Ben Wagner, Red Lion, PA (US); Nathan Meyer, Seven Valleys, PA (US); Barbara Stutzman Wilt, York Haven, PA (US)

Correspondence Address: BIRCH STEWART KOLASCH & BIRCH, PO BOX 747, FALLS CHURCH, VA, 22040-0747, US

(73) Assignee: ADHESIVES RESEARCH, INC., Glen Rock, PA (US)

(21) Appl. No.: 11/003,407

(22) Filed: Dec. 6, 2004

Related U.S. Application Data
(63) Continuation-in-part of application No. PCT/US03/23494, filed on Jul. 29, 2003.
(60) Provisional application No. 60/398,728, filed on Jul. 29, 2002.

(51) Int. Cl. B32B 27/30

(52) U.S. Cl. 428/343; 526/931

(57) ABSTRACT

A pressure sensitive adhesive composition is provided comprised of a cross-linked multifunctional liquid polymer having a Tg<20° C., at least one tackifying resin compatible with the liquid polymer, and at least one additional resin which is either incompatible or at least partially incompatible with the liquid polymer.

This application is a continuation-in-part application of International Application PCT/US03/23494, filed Jul. 29, 2003, which claims priority of U.S. provisional application 60/398,728, filed Jul. 29, 2002, the entire contents of which are each herein incorporated by reference, and for which priority is claimed under 35 U.S.C. 120.

### BACKGROUND AND SUMMARY OF THE INVENTION

The present invention is directed to a high strength pressure sensitive adhesive.

It is desirable in the art to provide a high strength pressure sensitive adhesive that adheres to a variety of surfaces including surfaces of low surface energy. More particularly, it is desirable to provide a high strength pressure sensitive adhesive that exhibits excellent peel, tack and shear properties as well as structural strength, each at a variety of temperature conditions.

U.S. Pat. Nos. 4,463,115; 4,593,068; and 4,687,818 are directed to various types of adhesive compositions. U.S. Pat. No. 4,463,115 is directed to a pressure sensitive adhesive comprised of a polyether having at least one silicon-containing hydrolyzable group and a tackifier. U.S. Pat. No. 4,593,068 is directed to a curing composition which is useful as a pressure sensitive adhesive comprised of a polyether having at least one reactive silicon-containing group and an acrylate polymer. U.S. Pat. No. 4,687,818 is directed to a pressure sensitive adhesive obtained by polymerizing a polymerizable monomer in the presence of an organic polymer having at least one reactive silicon functional group and/or an organic polymer having at least one olefinic group. However, such compositions do not exhibit the desired high strength properties.

The present invention is directed to a high strength pressure sensitive adhesive which may be tailored to achieve a variety of physical properties.

In one embodiment the pressure sensitive adhesive of the invention may be comprised of a cross-linked multifunctional liquid polymer having a Tg<20° C., a compatible tackifying resin such as a terpene phenolic resin, and an additional resin such as a petroleum resin, a terpene resin, a hindered phenolic resin, or an acrylic polymer which are either incompatible or at least partially incompatible with the liquid polymer.

In another embodiment, the pressure sensitive adhesive of the invention may be comprised of a cross-linked multifunctional liquid polymer having a Tg<20° C., a compatible tackifying resin such as a terpene phenolic resin, and an additional resin such as a petroleum resin, a terpene resin, a hindered phenolic resin, or an acrylic polymer, which is either incompatible or at least partially incompatible with the liquid polymer, with the acrylic polymer having a Tg>20° C. and a molecular weight less than 20,000.

In yet another embodiment, the pressure sensitive adhesive of the invention may be comprised of a cross-linked multifunctional liquid polymer having a Tg<20° C., a compatible tackifying resin such as a terpene phenolic resin, and an additional resin selected from the group consisting of a petroleum resin, a terpene resin and a hindered phenolic resin which is either incompatible or at least partially incompatible with the liquid polymer, and a cross-linked acrylic polymer having a Tg>20° C. and a molecular weight less than 20,000, said acrylic polymer including functionalities which permit cross-linking of the acrylic polymer and optionally reaction with the liquid polymer.

Once formed, the pressure sensitive adhesive of the invention consists of domains of the at least one cross-linked polymer in combination with the resins, optionally with an additional cross-linked acrylic polymer which may also react with the polymer, and if present, provides an interpenetrating polymer matrix for the cross-linked polymer.

### DETAILED DESCRIPTION OF THE INVENTION

The pressure sensitive adhesive composition of the present invention is comprised of a blend of a cross-linked liquid polymer, at least one tackifying resin which is compatible with the liquid polymer, and at least one resin which is incompatible or at least partially incompatible with the liquid polymer.

The multifunctional liquid polymer employed in the adhesive composition of the present invention has a Tg<20° C., and has reactive groups (preferably on each end) which are capable of reaction. The multifunctional liquid polymer is multifunctional; i.e., the polymer may be, e.g., di- or tri or higher functional.

One class of suitable liquid difunctional polymers for use in the present invention consists of silyl-terminated polyethers. This class of polymers comprises a polyether having at least one reactive silicon-containing group represented by the formula: 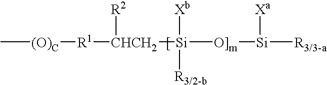
wherein R¹ is a bivalent organic group having from 1 to 20 carbon atoms, R² is hydrogen or a monovalent organic group having 1 to 20 carbon atoms, R³ is monovalent hydrocarbon group or a triorganosiloxy group, a is 0-3, b is 0-2, c is 0 or 1, with the proviso that 1≦a+b≦4, X is a silanol group or a hydrolyzable group, and m is 0-18.

The polyether to which the silyl termination is attached may be defined by the formula —R⁴O— where R⁴ is a bivalent organic group, preferably having from 1 to 8 carbon atoms. Exemplary R⁴ moieties include but are not limited to —CH₂—, —CH₂CH₂—, —CH(CH₃)CH₂—, CH(C₂H₅)CH₂—, —C(CH₃)₂CH₂—, —CH₂CH₂CH₂CH₂—, etc. Preferably, the polyether includes from 20 to 1000 repeat ether units.

The molecular weight of the liquid polymer will generally range from 500 to 100,000, and preferably from 3,000 to 50,000. Silyl-terminated polyethers are disclosed, for example, in U.S. Pat. No. 4,593,068 and 4,463,115, each herein incorporated by reference in their entirety.

The compatible and incompatible resins that may be used in combination with the liquid polymer are well-known to those of ordinary skill in the art. For instance, U.S. Pat. No. 4,463,115 discloses rosin resins such as rosin, rosin ester or a hydrogenated rosin ester; a phenolic resin; a hindered phenol resin, a modified phenolic resin such as a terpene-phenol resin; and a xylene resin, which, when used in the present invention, should be at least substantially compatible with the liquid polymer so as to form a substantially single phase when admixed therewith. Such compatible resins serve as tackifier resins for the liquid polymer, and are intended to raise the Tg of the mixture to an extent that the mixture exhibits pressure sensitive adhesive properties. Mixtures of the resins may also be employed. See column 3, lines 10-20 of the patent.

See, also, Table 1 of U.S. Pat. No. 4,463,115 which discloses various combinations of the above resins with the above liquid polymer, with the pressure sensitive adhesive properties of the combination being determined.

For purposes of the present invention, the compatibility of the resin(s) with the liquid polymer is determined according to the following method. To 100 parts by weight of the liquid polymer is added 100 parts by weight of the resin (based on solids content of a solution of the resin in a solvent) to form a blend. A uniform solution formed therefrom is thinly applied to a glass plate, and the solvent caused/permitted to evaporate at ambient or slightly elevated temperature so as to avoid any curing of the blend. The compatibility of the two components is determined accordingly to the following schedule: compatible (no haze observed), partially compatible (light spots observed), partially incompatible (spots clearly observed), and incompatible (cloudiness observed throughout the blend).

It is indeed surprising that the addition of an incompatible or at least partially incompatible resin to the mixture of the liquid polymer and the compatible resin significantly enhances the pressure sensitive properties of the composition.

It is noted in this regard that Table 1 of the '115 patent teaches that petroleum resins are incompatible with the liquid polymer, and that the combination of the petroleum resin and the liquid polymer does not result in desirable pressure sensitive adhesive properties. The same result was said to occur with respect to the terpene resin, with the modified phenolic resin not providing optimum properties.

However, it has been unexpectedly determined that such resins, even if incompatible or partially incompatible with the liquid polymer, can enhance the pressure sensitive properties of the composition when used in association with compatible tackifying resins. Exemplary incompatible resins include but are not limited to aliphatic petroleum resins; aromatic petroleum resins; terpene resins, or mixtures thereof.

This result is especially enhanced when an acrylic polymer is additionally present which is incompatible or at least partially incompatible with the liquid polymer. Suitable acrylic polymers have a Tg>20° C. and a molecular weight<20,000. Preferably, the acrylic polymer has a molecular weight greater than 1,000 to minimize the extent of compatibility of the acrylic polymer with the liquid polymer.

Such acrylic polymers may be comprised of a variety of monomers.

Exemplary (meth)acrylate monomers include but are not limited to esters of (meth)acrylic acid with non-tertiary alcohols such as 1-butanol, 1-pentanol, 2-pentanol, 3-pentanol, 2-methyl-1-butanol, 1-methyl-pentanol, 2-methyl-1-pentanol, 3-methyl-1-pentanol, 2-ethyl-1-butanol, 3,5,5-trimethyl-1-hexanol, 3-heptanol, 2-octanol, 1-decanol, 1-dodecanol, etc.

Further examples of monomers are (meth)acrylic monomers such as (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, toluyl (meth)acrylate, benzyl (meth)acrylate, Isobornyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, .gamma.-(methacryloyloxypropyl)trimethoxysilane, (meth)acrylic acid-ethylene oxide adducts, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate and 2-perfluorohexadecylethyl (meth)acrylate; styrenic monomers such as styrene, vinyltoluene, α.-methylstyrene, chlorostyrene, styrenesulfonic acid and salts thereof; fluorine-containing vinyl monomers such as perfluoroethylene, perfluoropropylene and vinylidene fluoride; silicon-containing vinyl monomers such as vinyltrimethoxysilane and vinyltriethoxysilane; maleic anhydride, maleic acid, maleic acid monoalkyl esters and dialkyl esters; fumaric acid, fumaric acid monoalkyl esters and dialkyl esters; maleimide monomers such as maleimide, methylmaleimide, ethylmaleimide, propylmaleimide, butylmaleimide, hexylmaleimide, octylmaleimide, dodecylmaleimide, stearylmaleimide, phenylmaleimide and cyclohexylmaleimide; nitrile group-containing vinyl monomers such as acrylonitrile and methacrylonitrile; amide group-containing vinyl monomers such as acrylamide and methacrylamide, N-(iso-butoxymethyl)acrylamide, N-methyl methylol acrylamide, N-Methylol acrylamide, methylacrylamidoglycolate methyl ether; vinyl esters such as vinyl acetate, vinyl propionate, vinyl pivalate, vinyl benzoate and vinyl cinnamate; alkenes such as ethylene and propylene; conjugated dienes such as butadiene and isoprene; vinyl chloride, vinylidene chloride, allyl chloride, allyl alcohol and so on.

The above monomers may be used singly or a plurality of them may be used for copolymerization. In the above context, “(meth)acrylic acid” means acrylic acid and/or methacrylic acid.

By proper selection of the respective monomers, one of ordinary skill in the art can modify the properties of the acrylic resin (such as Tg, molecular weight) to enhance the incompatibility of the acrylic polymer with the liquid polymer. Such acrylic polymers are well known to those of ordinary skill in the art.

By way of further advantage, it has been demonstrated that the combination of the petroleum resin results in an adhesive having highly desirable adhesion to low surface energy surfaces, the combination of the hindered phenolic resin has applicability to good film-formation of the adhesive, and the combination of the terpene resin has good applicability to the reinforcement of the adhesive.

Advantageously, an acrylic polymer may be employed which includes cross-linkable functionalities thereon. Cross-linking functionalities may also be employed which will permit cross-linking of the acrylic polymer to the multifunctional liquid polymer. The polymer may be mono- or multi-functional. Correspondingly, a non-cross-linkable acrylic polymer may be employed in conjunction with a separate cross-linkable acrylic polymer.

The acrylic polymer can be cross-linked by reaction of functional groups by condensation, addition or ring opening reactions. The requisite cross-linking reaction can occur by means of condensation (either thermal or photoinitiated), cationic (either thermal or photoinitiated) reaction and/or free radical (either thermal or photoinitiated) reaction.

Exemplary functional groups which may be employed include but are not limited to (meth)acrylate, epoxy, vinyl ether, propenyl ether, alkoxy silane, isocyanate, hydroxyl, amine, acid, etc. The chemical linking groups that are employed to attach the groups are not critical to the practice of the claimed invention and can be readily determined by one skilled in the art. Examples of useful chemical bonds/linkages include but are not limited to ester, urea, amide, urethane, ether and sulfide. With respect to the specific functional groups to be employed, the choice of complementary functional groups may be determined by one skilled in the art. For instance, isocyanate groups will cross-link with hydroxyl and amine groups. Acid groups will cross-link with hydroxyl, epoxy and amine groups. Epoxy groups will cross-link with hydroxyl groups. By way of example, a hydroxyl-functional acrylic polymer will cross-link with an epoxy-functional acrylic polymer.

Exemplary functional groups that may be employed in the present invention include: 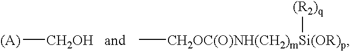
where m is an integer from 1 to 6, p is an integer from 1 to 3 and q is an integer from 0 to 2; where (OR) is a hydrolyzable moiety wherein R is selected from the group consisting of a hydrocarbon having from 1 to 5 carbon atoms and —C(O)R₁ wherein R₁ is a hydrocarbon having from 1 to 5 carbon atoms, and wherein R₂ is a C₁₋₆ hydrocarbon; and 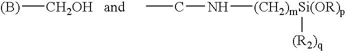
where m is an integer from 1 to 6, p is an integer from 1 to 3, and q is an integer from 0 to 2; where (OR) is a hydrolyzable moiety wherein R is selected from the group consisting of a hydrocarbon having from 1 to 5 carbon atoms and —C(O)R₁ wherein R₁ is a hydrocarbon having from 1 to 5 carbon atoms, and wherein R₂ is a C₁₋₆ hydrocarbon.

Exemplary R groups include alkyl groups. Exemplary R₁ groups include acetoxy 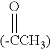
groups. Exemplary R₂ groups include C₁₋₆ straight or branched alkyl groups or alkene groups. One skilled in the art is able to select suitable R and R′ groups for use in such functional groups. See, for example, EP 433 070 which discloses hydrolyzable silane functional groups.

The presence of the cross-linkable acrylic polymer enables the structural properties of the adhesive to be enhanced as a result of the reinforcement of the adhesive by the cross-linking of the polymer, resulting in enhanced shear strength and internal strength of the pressure sensitive adhesive composition . This result is due to the fact that when the reactive acrylic polymer is caused to cross-link, it becomes less if not substantially incompatible with the other components of the blend. The cross-linked polymer thus forms an incompatible phase domain in the cross-linked liquid polymer matrix, thus providing physical stability for the remaining components of the adhesive composition.

When present, the cross-linkable acrylic polymer may be cross-linked either internally or externally. That is, when sufficient functionality exists on the polymer, the polymer may be cross-linked upon exposure to a suitable triggering mechanism, such as elevated temperatures or a cross-linking catalyst.

Such cross-linkable acrylic polymers are well-known in the art. By way of example, a suitable cross-linkable functional acrylic polymer for use in the present invention and which is incompatible with Kaneka liquid polyether polymer SAX 725 comprises isobornylacrylate, methyl methacrylate, t-butyl methacrylate, and 3-methacryloxypropyltrimethoxysilane in a monomer weight ratio of 15:40:43.5:1.5. The polymer has a Tg of 78° C., Mn of 4,400, and Mw of 6,640.

Alternatively, an external cross-linking agent may be added to assist in the thermal curing of the adhesive composition. Exemplary cross-linking agents are disclosed in U.S. Pat. Nos. 3,714,096; 3,923,931; 4,454,301; 4,950,708; 5,194,486; 5,214,094; 5,420,195; and 5,563,205, each herein incorporated by reference.

Exemplary cross-linking agents include polyfunctional compounds having at least two non-conjugated carbon-to-carbon double bonds. Exemplary polyfunctional compounds include but are not limited to diallyl maleate, diallyl phthalate, and multi-functional acrylates and methacrylates (such as polyethylene glycol diacrylate, hexane diol diacrylate, ethoxylated trimethylolpropane triacrylate, pentaerythritol triacrylate, propylene glycol diacrylate and trimethylolpropane trimethylacrylate). Such cross-linking agents are disclosed in U.S. Pat. Nos. 5,420,195 and 5,563,205, each herein incorporated by reference.

By way of specific example, suitable cross-linking agents which may be employed include the following:

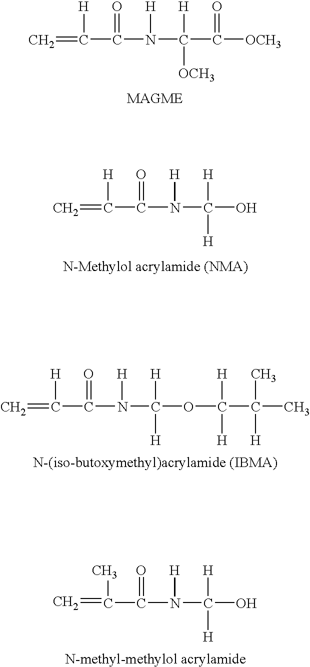

Combinations of the above cross-linking compounds may also be employed.

A curing agent, if present, should have a sufficiently low activation temperature such that the blend may be thermocured at a desirably low temperature. Exemplary curing agents include but are not limited to dicyanamides, imidazoles, ketamines, modified amines and substituted ureas, dicarboxylic acids, mercaptans, acid anhydrides, dihidrizide compounds, polyfunctional amines, cationic UV cure photoinitiators, peroxides and azo compounds.

While the cross-linking reaction may be carried out in the presence of a non-reactive solvent, the reaction can advantageously occur in the substantial absence of a solvent. Preferably, the solvent will be present in an amount of up to about 20 percent by weight. The solvent may be removed from the product of the reaction step (such as by heating). Exemplary non-reactive solvents include ketones, alcohols, esters and hydrocarbon solvents, such as ethyl acetate, toluene and xylene.

Alternatively, the preformed mixture may be coated onto a web and cured under suitable conditions.

As noted above, the curing of the pressure sensitive adhesive of the present invention may occur by free radical-initiated copolymerization in the presence of a suitable catalyst such as peroxides, diazo compounds, etc. known to those skilled in the art. Such polymerization may be conducted in the substantial absence of a solvent. Suitable polymerization temperatures range from about 20° C. to about 150° C. for periods of time of from 2 to 24 hours until the desired degree of conversion occurs.

The reactants may also be polymerized by radiation curing in the presence of the diluent. In the present invention the term “radiation” means light rays, such as ultraviolet rays, or ionizing radiation such as an electron beam. Preferably, ultraviolet lamps are used which emit UV light in the wavelength range absorbed by the particular photoinitiator used. Several different lamps which are commercially available may be used. These include medium pressure mercury lamps and low intensity fluorescent lamps, each having various emission spectra and emission maxima between 280 and 400 nanometers. Commercially available fluorescent black lights with a maxima at 351 nanometers and 90% of the emissions between 300 and 400 nanometers (nm) may be utilized. In general, the total radiation dose should be between about 400-600 milliJoules/cm². It is preferable that at least about 75 percent of the radiation be between 300 and 400 nm.

If the reaction is to be cured by exposure to nonionizing radiation, such as ultraviolet radiation, then a photoinitiator is also present in the composition. The photoinitiator, if present, is employed at a concentration of from about 0.1 to 10 weight percent, preferably from 0.5 to 5 weight percent based on the total weight of the radiation curable composition.

The photoinitiators which may be used are well known to those skilled in the art. Such photoinitiators include but are not limited to 2,2-diethoxyacetophenone, 2,2-dimethoxyphenoxyacetophenone, 2- or 3- or 4-bromoacetophenone, 3- or 4-allylacetophenone, 2-acetonaphthone, benzaldehyde, benzoin, the allyl benzoin ethers, benzophenone, benzoquinone, 1-chloroanthraquinone, Michler's Ketone, p-methoxybenzophenone, dibenzosuberone, 4,4-dichlorobenzophenone, 1,3-diphenyl-2-propanone, fluorenone, 1,4-naphthyl-phenylketone, 2,3-pentanedione, propiophenone, chlorothioxanthone, 2-methylthioxanthone xanthone or mixtures thereof.

It is well known that acrylate polymers may be prepared by radiation curing of monomer admixtures. See, for example, U.S. Pat. Nos. 4,181,752; 4,379,201; 4,421,822; 4,513,039; 4,522,870; 4,587,313; 4,665,106; 5,183,833; 4,737,559; 5,302,629; 5,462,977; 5,536,759; 5,552,451; 5,618,899 and 5,683,798.

If present, the cross-linkable acrylic polymer may be caused to become cross-linked at the same time that the liquid polymer is cross-linked. However, the extent to which the acrylic polymer becomes cross-linked during the cross-linking of the liquid polymer is dependent upon the cross-linking conditions that are employed. It is also possible for the multifunctional liquid polymer to be cross-linked (or reacted) prior to the cross-linking (or reaction) of any reactive acrylic polymer which may be present, if for example, the multifunctional liquid polymer is susceptible to cross-linking at less severe conditions than those which are necessary for cross-linking of the reactive acrylic polymer. If so, such cross-linking can occur by passing the mixture of the liquid polymer, any tackifiers which are present and the reactive acrylic polymer, together with any optional cross-linking agents, etc., through a drying/curing oven whereby the multifunctional liquid polymer will be caused to cross-link. Any reactive acrylic polymer which is present will cross-link and/or react with the liquid polymer as the mixture passes through higher temperature zones of the oven.

The liquid polymer will generally be present in the adhesive composition in an amount ranging from about 15 to 80% by wt., preferably from about 40 to 50% by wt, based on the total weight of the adhesive composition. Higher amounts of the liquid polymer will result in higher tack values, while lower values will result in higher peel values.

The resins (both compatible and incompatible) are generally present in an amount ranging from about 20 to 85% by wt., preferably from about 47 to 60% by wt., based on the total weight of the adhesive composition.

The reactive acrylic polymer will generally be present in an amount of less than about 30 % by wt., and preferably less than about 20% by wt. At amounts greater than about 30% by wt., upon being cross-linked, the resulting degree of incompatibility may be so great as to reduce the adhesive properties of the composition to unacceptable low levels.

The total incompatible resin content will generally be in the range of 5% to about 50% of the total resin content (both compatible and incompatible), and preferably in an amount of about 10 to 25% of the total resin content. The ratio of compatible to incompatible resins will vary based on the degree of incompatibility of the resin and the desired properties. The incompatible phase will increase the cohesive nature of the polymer by acting as a reinforcing phase, thus dramatically increasing the shear properties. Eventually, with increasing levels of the reinforcing phase, a detrimental effect on the adhesive nature will be seen. The higher the degree of incompatibility, the more effective the resin will be acting as an incompatible phase. When using an acrylic polymer the degree of incompatibility can be tailored through the selection of monomers in the acrylic polymer, thus allowing one to change the degree of reinforcement without having to change the level of resin.

The above novel adhesive composition may be coated onto a backing material by any conventional manner, such as by roll coating, spray coating, or extrusion coating, etc. by use of conventional extrusion devices. As discussed above, the composition may be coated either with or without a solvent, with the solvent subsequently removed to leave the tacky adhesive layer on the backing material.

The pressure sensitive adhesive properties of the compositions of the present invention enable the compositions to be used in association with a variety of body members (e.g., tapes, patches, strips, labels, etc.) to provide an adhesive assembly. For example, the body member may be in the form of a backing material coated on at least one side thereof with the adhesive to provide an adhesive-backed sheet film or tape.

Exemplary backing materials used in the production of such a product include but are not limited to flexible and inflexible backing materials conventionally employed in the area of pressure sensitive adhesives, such as creped paper, kraft paper, fabrics (knits, non-wovens, wovens), foil and synthetic polymer films such as polyethylene, polypropylene, polyvinyl chloride, poly(ethylene terephthalate) and cellulose acetate, as well as glass, ceramics, metallized polymer films and other compatible sheet or tape materials.

### EXAMPLE 1

100 parts of polyether having silicon-containing hydrolyzable groups (Kaneka SAX 725) and a room temperature viscosity of 100,000 cps were charged into a mixing vessel. To the vessel 75 parts of compatible resin (terpene phenolic resin SP-553—Schennectady Chemical Co.) and 15 parts of incompatible resin (styrenated terpene resin ZT 115LT—Arizona Chemical Co.), both in 80% solution, were added. A titanium catalyst was then added to the mixture.

The above mixture was then coated onto a 2 mil polyester film. To remove the solvent, the coated film was heated for 4 minutes at 66° C. followed by heating for 3 minutes at 150° C., resulting in a 2 mil pressure sensitive adhesive film. The performance of the film is shown in Table 1 below.

The tack was measured using a Rolling Ball tack testing device. The distance the ball rolled on the adhesive tape is recorded in inches, in accordance with PSTC-6, ASTM D3121-94.

The peel was measured using a standard 1800 Peel test 23° C. and 50% Relative Humidity to both stainless steel and polypropylene test panels. Peel measurements were taken using a pull rate of 12 inches per minute. All test samples were allowed 5 minutes or 72 hours to dwell on the panel before being tested in accordance with PSTC-1, ASTM D3330-83.

The shear of the adhesive was tested using a 2, 3, or 4 Kg weight hanging from a quarter square inch of adhesive on a stainless steel panel. The time until failure and the transfer were noted on all samples in accordance with PSTC-7 8/89 Revision.

TABLE 1

| | |
|---|---|
| Thickness (mil) | 2.0 |
| Rolling ball tack | FR 0.5 |
| 5 min 180° peel to | 94.9 oz/in (NT) |
| SS (transfer) | |
| 5 min 180° peel to | 91.4 oz/in (NT) |
| PP (transfer) | |
| 3 kg/0.25 in² shear (transfer) | 593.4 (NT) |
| minutes | |

### EXAMPLE 2

100 parts of polyether having silicon-containing hydrolyzable groups (Kaneka SAX 725) and a room temperature viscosity of 100,000 cps were charged into a mixing vessel. To the vessel 115 parts of compatible resin in 80% solution (blend of Ribetak 7081 (terpene phenolic resin—Elf Atochem), Wingtack 10 (hydrocarbon resin-Goodyear), and Wingstay L (butylated reaction product of p-cresol and dicyclopentadiene-Goodyear) in a ratio of 90:15:10, respectively) and 45 parts partially incompatible crosslinkable acrylic resin having silyl, hydroxy, and isobutyoxyl functional groups in 65% solution were added. The partially incompatible acrylic resin has an Mn of 5950 and a Mw of 9240. A catalyst was then added to the mixture.

The above mixture was then coated onto a 2 mil polyester film. To remove the solvent, the coated film was heated for 4 minutes at 66° C. followed by heating for 3 minutes at 150° C., resulting in a 5 mil pressure sensitive adhesive film. The performance of the film is shown in Table 2.

TABLE 2

| | |
|---|---|
| Thickness (mil) | 5.0 |
| Rolling ball tack | QR 2.5 |
| 72 hr 180° peel to | 209.6 oz/in (NT) |
| SS (Transfer) | |
| 72 hr 180° peel to | 170.2 oz/in (NT) |
| PP (Transfer) | |
| 2 kg/0.25 in² shear in minutes | 6461.6 (residue) |
| (Transfer) | |
| 4 kg/0.25 in² shear in minutes | 680.3 (residue) |
| (Transfer) | |

### EXAMPLE 3

A blend of the following components is formed:

| | |
|---|---|
| Liquid polyether polymer | 100 pts by wt |
| (Kaneka SAX 725) | |
| Compatible tackifier | 60 pts by wt |
| (SP-553 terpene | |
| phenolic resin) | |
| Compatible tackifier | 15 pts by wt |
| (Wingstay L - | |
| butylated reaction product | |
| of p-cresol and dicyclopentadiene) | |
| Incompatible tackifier | 15 pts by wt |
| (ZT 115LT - styrenated | |
| terpene resin) | |
| Adhesion promoter | 1 pt by wt |
| Titanium curing catalyst | 4 pts by wt |

The resulting blend is coated on a 5 mil film and dried at 300° F. for 4 minutes, and the adhesive properties determined as shown below:
PP peel adhesion 4.9 #/in
SS peel adhesion 5.6 #/in
4 kg/0.25 in² shear: 64 minutes
Rolling ball tack (ASTM D3121-94): FR 2

### EXAMPLE 4

The blend of Example 3 is employed, with the exception that 20 parts by weight of an incompatible crosslinkable acrylic polymer having silyl, hydroxy and isobutoxy functional groups is incorporated into the blend. The blend is coated and formed into a film in the same manner as in Example 3. The performance of the resulting film is shown below:
PP peel adhesion: 6.3#/in
SS peel adhesion: 9.7#/in
4 kg/0.25 in² shear: 294 minutes
Rolling ball tack (ASTM D3121-94): FR 3

It is thus shown that the presence of the incompatible resin in the composition dramatically improves peel and shear properties without compromising tack or low energy adhesion properties. This result is indeed surprising and unexpected in view of the teachings of the prior art.

1. A pressure sensitive adhesive composition comprised of a cross-linked multifunctional liquid polymer having a Tg<20° C., at least one tackifying resin compatible with the liquid polymer, and at least one additional resin which is incompatible or at least partially incompatible with the liquid polymer.

2. The pressure sensitive adhesive composition of claim 1, wherein said at least one incompatible resin comprises an acrylic polymer having a Tg>20° C. and a molecular weight less than 20,000.

3. The pressure sensitive adhesive composition of claim 2, wherein said acrylic polymer includes functionalities which permit cross-linking of the acrylic polymer and optionally reaction with said liquid polymer.

4. The pressure sensitive adhesive composition of claim 3, wherein said acrylic polymer is cross-linked.

5. The pressure sensitive adhesive composition of claim 4, wherein said cross-linked acrylic polymer forms incompatible phase domains in said cross-linked liquid polymer.

6. The pressure sensitive adhesive composition of claim 1, wherein said compatible tackifying resin is selected from the group consisting of a rosin resin, a rosin ester, a hydrogenated rosin ester, a phenolic resin, a modified phenolic resin, a hindered phenol resin, a xylene resin, and mixtures thereof.

7. The pressure sensitive adhesive composition of claim 1, wherein said incompatible or at least partially incompatible resin is selected from the group consisting of a terpene resin, an aliphatic petroleum resin, an aromatic petroleum resin, and mixtures thereof.

8. The pressure sensitive adhesive composition of claim 1, wherein said multifunctional liquid polymer is di-, tri- or higher functional.

9. The pressure sensitive adhesive composition of claim 1, wherein said multifunctional liquid polymer comprises a silyl-terminated polyether.

10. The pressure sensitive adhesive composition of claim 9, wherein said silyl-terminated polyether includes at least one reactive silicon-containing group represented by the formula: 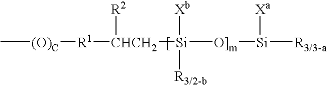
wherein R¹ is a bivalent organic group having from 1 to 20 carbon atoms, R² is hydrogen or a monovalent organic group having 1 to 20 carbon atoms, R³ is monovalent hydrocarbon group or a triorganosiloxy group, a is 0-3, b is 0-2, c is 0 or 1, with the proviso that 1 a+b 4, X is a silanol group or a hydrolyzable group, and m is 0-18.

11. The pressure sensitive adhesive composition of claim 10, wherein said polyether is defined by the formula —R⁴O— where R⁴ is a bivalent organic group having from 1 to 8 carbon atoms.

12. The pressure sensitive adhesive composition of claim 11, wherein said R⁴ moiety is selected from the group consisting of —CH₂—, —CH₂CH₂—, —CH(CH₃)CH₂—, CH(C₂H₅)CH₂—, —C(CH₃)₂CH₂—, and —CH₂CH₂CH₂CH₂—.

13. The pressure sensitive adhesive composition of claim 1 wherein the molecular weight of said liquid polymer ranges from 500 to 100,000.

14. The pressure sensitive adhesive composition of claim 13, wherein the molecular weight of said liquid polymer ranges from 3,000 to 50,000.

15. The pressure sensitive adhesive composition of claim 1, wherein said acrylic polymer contains both cross-linkable and non-cross-linkable functionalities.

16. The pressure sensitive adhesive composition of claim 3, wherein said acrylic polymer includes functionalities selected from the group consisting of (meth)acrylate, epoxy, vinyl ether, propenyl ether, alkoxy silane, isocyanate, hydroxyl, amine and acid.

17. The pressure sensitive adhesive composition of claim 1, further including an external cross-linking agent.

18. The pressure sensitive adhesive composition of claim 1, wherein said liquid polymer is present in said adhesive composition in an amount ranging from about 15 to 80% by wt.

19. The pressure sensitive adhesive composition of claim 18, wherein said liquid polymer is present in said adhesive composition in an amount ranging from 40 to 50% by wt.

20 The pressure sensitive adhesive composition of claim 1, wherein said resins are present in an amount ranging from about 20 to 85% by wt. based on the total weight of the adhesive composition.

21. The pressure sensitive adhesive composition of claim 20, wherein resins are present in an amount ranging from about 47 to 60% by wt. Based on the total weight of the adhesive composition.

22. The pressure sensitive adhesive composition of claim 3, wherein said reactive acrylic polymer is present in an amount of less than about 30% by wt. based on the total weight of the composition.

23. The pressure sensitive adhesive composition of claim 22, wherein said reactive acrylic polymer is present in an amount of less than about 20% by wt. based on the total weight of the composition.

24. The pressure sensitive adhesive composition of claim 1, wherein said incompatible resin is present in an amount of from 5 to 50% by wt. based on the total weight of the resins in said composition.

25. The pressure sensitive adhesive composition of claim 23, wherein said incompatible resin is present in an amount of from 25 to 50% by wt. based on the total weight of the composition.

26. The pressure sensitive adhesive composition of claim 1, in the form of a tape.

27. The pressure sensitive adhesive composition of claim 2, in the form of a tape.

28. The pressure sensitive adhesive composition of claim 3, in the form of a tape.

29. A method for the production of a pressure sensitive adhesive composition comprised of a cross-linked multifunctional liquid polymer having a Tg<20° C., at least one tackifying resin compatible with the liquid polymer, and at least one additional resin which is incompatible with the liquid polymer, said method comprising the steps of:
combining said multifunctional liquid polymer having a Tg<20° C., said at least one compatible tackifying resin, and at least one additional resin which is incompatible or at least partially incompatible with said liquid polymer, and cross-linking said multifunctional liquid polymer to form said pressure sensitive adhesive composition.

30. The method of claim 29, wherein said at least one incompatible or partially incompatible resin comprises an acrylic polymer having a Tg>20° C. and a molecular weight less than 20,000.

31. The method of claim 30, wherein said acrylic polymer includes functionalities which permit cross-linking of the acrylic polymer and optionally reaction with said liquid polymer.

32. The method of claim 31, wherein said acrylic polymer is cross-linked subsequent to the cross-linking of said liquid polymer.

33. The method claim 29, wherein said cross-linked multifunctional liquid polymer forms a matrix encompassing domains of said incompatible or partially incompatible resin.

34. The method of claim 26, wherein said compatible tackifying resin is selected from the group consisting of a rosin resin, a rosin ester, a hydrogenated rosin ester, a phenolic resin, a modified phenolic resin, a hindered phenol resin, a xylene resin, and mixtures thereof.

35. The method of claim 26, wherein said incompatible or at least partially incompatible resin is selected from the group consisting of a terpene resin, an aliphatic petroleum resin, an aromatic petroleum resin, and mixtures thereof.

36. The method of claim 29, wherein said multifunctional liquid polymer is di-, tri- or higher functional.

37 The method of claim 29, wherein said multifunctional liquid polymer comprises a silyl-terminated polyether.

38. The method of claim 37, wherein said silyl-terminated polyether includes at least one reactive silicon-containing group represented by the formula: 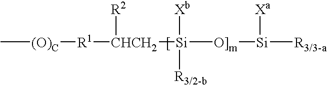
wherein R¹ is a bivalent organic group having from 1 to 20 carbon atoms, R² is hydrogen or a monovalent organic group having 1 to 20 carbon atoms, R³ is monovalent hydrocarbon group or a triorganosiloxy group, a is 0-3, b is 0-2, c is 0 or 1, with the proviso that 1 a+b 4, X is a silanol group or a hydrolyzable group, and m is 0-18.

39. The method of claim 38, wherein said polyether is defined by the formula —R⁴O— where R⁴ is a bivalent organic group having from 1 to 8 carbon atoms.

40. The method of claim 39, wherein said R⁴ moiety is selected from the group consisting of—CH₂—, —CH₂CH₂—, —CH(CH₃)CH₂—, CH(C₂H₅)CH₂—, —C(CH₃)₂CH₂—, and —CH₂CH₂CH₂CH₂—.

41. The method of claim 29 wherein the molecular weight of said liquid polymer ranges from 500 to 100,000.

42. The method of claim 41, wherein said molecular weight ranges from 3,000 to 50,000.

43. The method of claim 29, wherein said acrylic polymer contains both cross-linkable and non-cross-linkable functionalities.

44. The method claim 31, wherein said acrylic polymer includes functionalities selected from the group consisting of (meth)acrylate, epoxy, vinyl ether, propenyl ether, alkoxy silane, isocyanate, hydroxyl, amine and acid.

45. The method of claim 29, wherein an external cross-linking agent is also admixed to form said admixture.

46. The method of claim 29, wherein said liquid polymer is present in said adhesive composition in an amount ranging from about 15 to 80% by wt.

47. The method of claim 46, wherein said liquid polymer is present in said adhesive composition in an amount ranging from 40 to 50% by wt.

48 The method of claim 29, wherein said resins are present in an amount ranging from about 20 to 85% by wt. based on the total weight of the adhesive composition.

49. The method of claim 48, wherein resins are present in an amount ranging from about 47 to 60% by wt. based on the total weight of the adhesive composition.

50. The method of claim 31, wherein said reactive acrylic polymer is present in an amount of less than about 30% by wt. based on the total weight of the composition.

51. The method of claim 50, wherein said reactive acrylic polymer is present in an amount of less than about 20% by wt. based on the total weight of the composition.

52. The method of claim 29, wherein said incompatible resin is present in an amount of from 5 to 50% by wt. based on the total weight of the resins in said composition.

53. The method of claim 52, wherein said incompatible resin is present in an amount of from 25 to 50% by wt. based on the total weight of the composition.

54. The method of claim 29, wherein said multifunctional liquid resin is cross-linked by passing said admixture through a drying/curing oven at a temperature sufficient to cross-link said multifunctional liquid resin.

55. The method of claim 32, wherein said cross-linkable acrylic resin is cross-linked by passing said admixture through a drying/curing oven at a temperature sufficient to cross-link said acrylic resin.

56. The method of claim 29, wherein said multifunctional liquid resin is cross-linked by contacting said admixture with radiation.

57. The method of claim 32, wherein said cross-linkable acrylic resin is cross-linked by contacting said admixture with radiation.
